(19) United States
(12) Patent Application Publication
(10) Pub. No.: US 2021/0354886 A1
(43) Pub. Date: Nov. 18, 2021

(54) CONTAINER WITH POSITIONING MECHANISM

(71) Applicant: Oxti Corporation, Taipei (TW)

(72) Inventor: Chih Feng HO, Taipei (TW)

(21) Appl. No.: 16/876,161

(22) Filed: May 18, 2020

(51) Int. Cl. B65D 43/24; A45C 5/08; B65D 43/16; E05D 11/10

(52) U.S. Cl. CPC B65D 43/24; E05D 11/1028; B65D 43/163; A45C 5/08

(57) ABSTRACT

A container includes a housing, a casing pivotally connected to the housing with a pivot axle, one or more magnetic members engaged in the housing, and one or more magnetic elements engaged in the casing and disposed close to the magnetic member for acting with the magnetic member and for anchoring the casing to the housing at any selected angular position. The housing includes a slot formed in a seat, and the magnetic member is engaged in the slot of the seat. The housing includes a passage formed in the seat, and the pivot axle is engaged in the passage of the seat. The magnetic member includes an aperture formed in the magnetic member for receiving and engaging with the pivot axle.

### BACKGROUND OF THE INVENTION

### 1. Field of the Invention

The present invention relates to a container or case, and more particularly to a container including an improved and simplified latching or positioning structure or configuration for latching or locating a cover to a housing or a container or reservoir body and for anchoring or retaining or positioning the cover to the housing at any selected or suitable angular position or location.

### 2. Description of the Prior Art

Typical containers or reservoirs or tool boxes or cases comprise a container or reservoir body and a cover pivotally or rotatably attached or mounted or secured to the container body for pivotally coupling the cover and the container body together.

For example, U.S. Pat. No. 4,179,153 to Cole, Jr., U.S. Pat. No. 4,591,056 to Groch, and U.S. Pat. No. 4,901,882 to Goncalves disclose several of the typical cases with a hinged cover or the like.

However, the cover is normally pivotally or rotatably hinged or attached or mounted or secured to the container or case body with a pivot axle or hinge for pivotally or rotatably connecting or coupling the cover and the container body together, but the cover may not be anchored or retained to the container body at any selected or suitable angular position or location.

The present invention has arisen to mitigate and/or obviate the afore-described disadvantages of the conventional containers or tool boxes or cases.

### SUMMARY OF THE INVENTION

The primary objective of the present invention is to provide a container including an improved and simplified latching or positioning structure or configuration for latching or locating a cover to a housing or a container or reservoir body and for anchoring or retaining or positioning the cover to the housing at any selected or suitable angular position or location.

In accordance with one aspect of the invention, there is provided a container comprising a housing, a casing pivotally connected to the housing with a pivot axle, a magnetic member engaged in the housing, and a magnetic element engaged in the casing and disposed close to the magnetic member for acting with the magnetic member and for anchoring and positioning the casing to the housing at any suitable or selected angular position with the magnetic member and the magnetic element.

The housing includes a seat, and the magnetic member is engaged in the seat of the housing. The housing includes a slot formed in the seat, and the magnetic member is engaged in the slot of the seat of the housing. The housing includes a passage formed in the seat, and the pivot axle is engaged in the passage of the seat of the housing. The magnetic member includes an aperture formed in the magnetic member for receiving and engaging with the pivot axle.

The casing includes a protrusion, and the magnetic element is engaged in the protrusion of the casing. The casing includes a bore formed in the protrusion, and the pivot axle is engaged in the bore of the protrusion. The casing includes a pathway formed in the protrusion, and the magnetic element is engaged in the pathway of the protrusion. The magnetic element includes an orifice formed in the magnetic element for receiving and engaging with the pivot axle.

A second magnetic member may further be provided and engaged in the housing, and a second magnetic element engaged in the casing and disposed close to the second magnetic member for acting with the second magnetic member and for anchoring and positioning the casing to the housing at the selected angular position.

The housing includes a seat, and the second magnetic member is engaged in the seat of the housing. The housing includes a slot formed in the seat of the housing, and the second magnetic member is engaged in the slot of the seat. The second magnetic member includes an aperture formed in the second magnetic member for receiving and engaging with the pivot axle.

The casing includes a protrusion, and the second magnetic element is engaged in the protrusion of the casing. The casing includes a pathway formed in the protrusion, and the second magnetic element is engaged in the pathway of the protrusion. The second magnetic element includes an orifice formed in the second magnetic element for receiving and engaging with the pivot axle and for being stably anchored to the casing.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of a container in accordance with the present invention;

FIG. 2 is a side plan schematic view of the container;

FIG. 3 is a partial exploded view of the container;

FIG. 4 is another partial exploded view illustrating a housing or a container or reservoir body of the container; and

FIG. 5 is a further partial exploded view illustrating a cover member of the container.

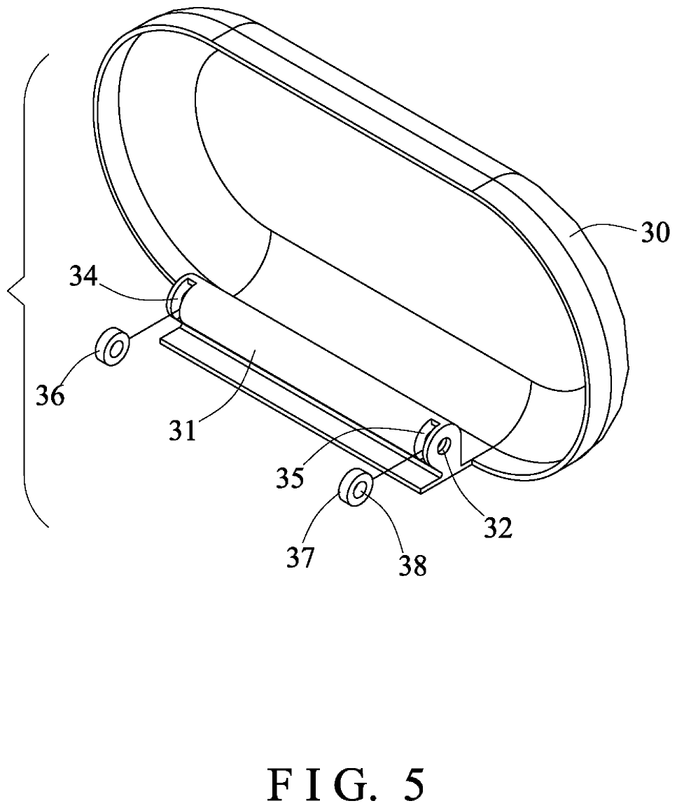

### DETAILED DESCRIPTION OF THE PREFERRED EMBODIMENT

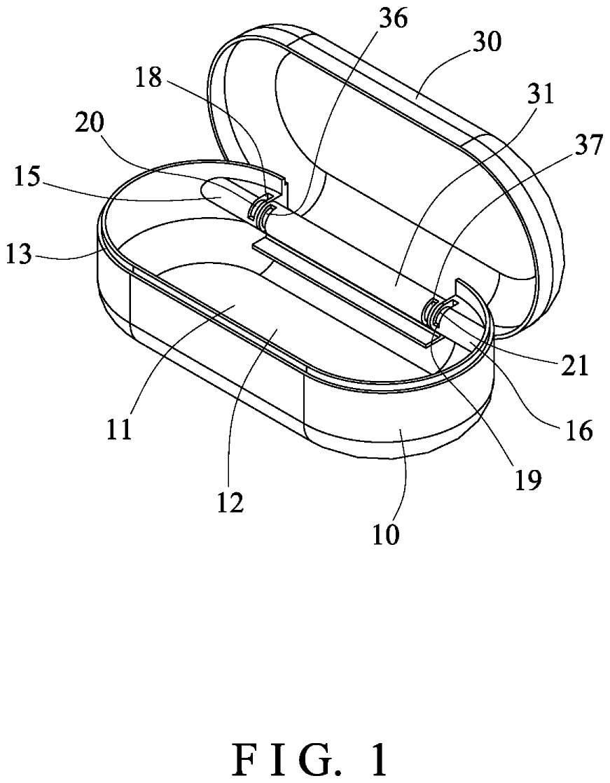

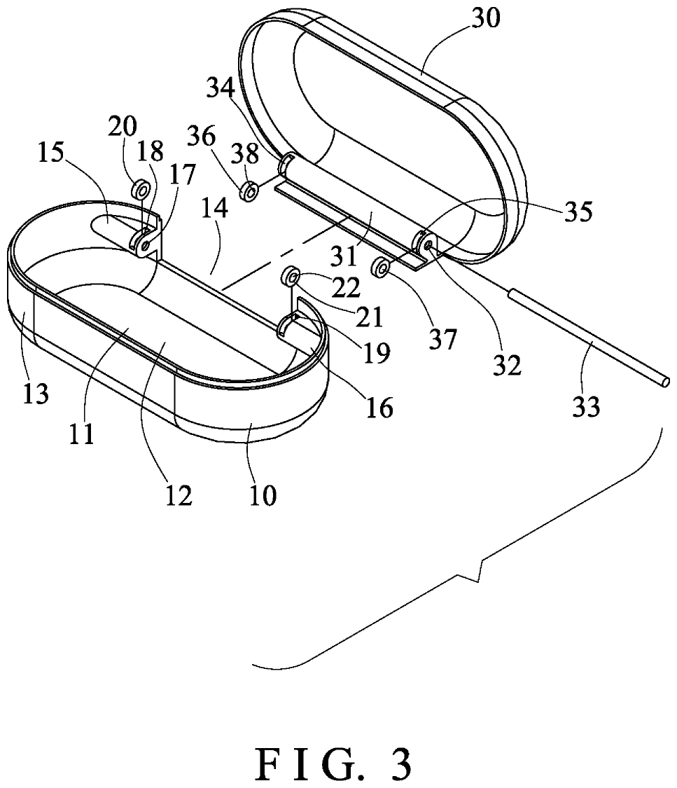

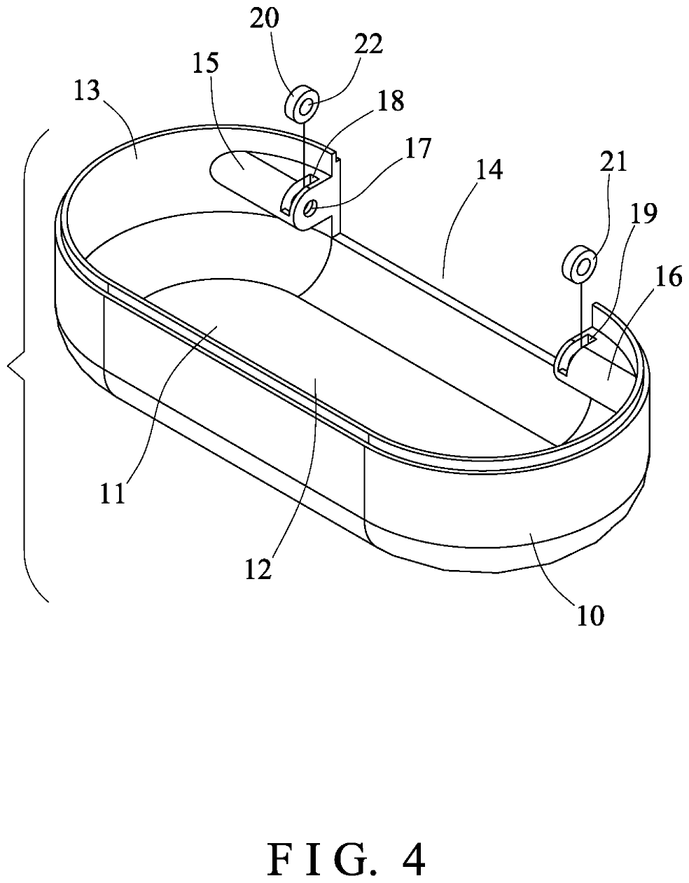

Referring to the drawings, and initially to FIGS. 1-3, a container or reservoir or housing or casing in accordance with the present invention comprises a container or reservoir body or a housing 10 including a compartment or chamber 11 formed therein and formed or defined by a bottom plate or panel 12 and an outer peripheral wall or fence 13, as shown in FIGS. 3 and 4, the housing 10 includes a notch or opening 14 formed in the peripheral fence 13 and formed or defined between two blocks or seats 15, 16, an orifice or passage 17 formed through the seats 15, 16. The seats 15, 16 each include a passageway or slot 18, 19 formed therein and intersected or communicating with the passage 17 of the seats 15, 16 of the housing 10. One or more (such as two) magnets or magnetic attractive members 20, 21 are received or engaged in the slots 18, 19 of the seats 15, 16 respectively.

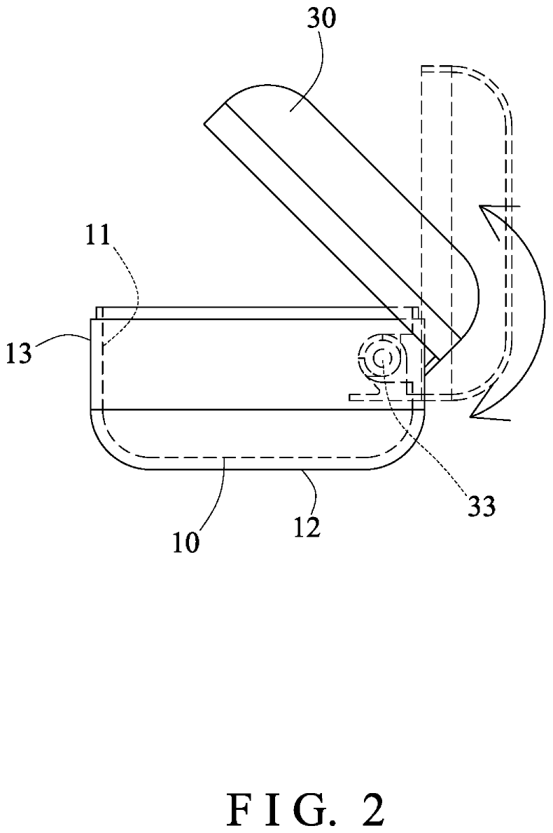

The container further includes a cover or casing 30 having a shaft or protrusion 31 to be disposed or engaged into the opening 14 of the housing 10 and to be disposed or engaged between the seats 15, 16, and having an aperture or bore 32 formed through the protrusion 31 and to be aligned with the passage 17 of the seats 15, 16 of the housing 10 for receiving or engaging with a spindle or pivot axle 33 and for allowing the casing 30 to be pivotally or rotatably connected or coupled to the housing 10, and thus for allowing the housing 10 and the casing 30 to be pivoted or rotated relative to each other between an opened (FIGS. 1, 2) and an enclosed position.

The casing 30 further includes one or more (such as two) pathways 34, 35 formed therein (FIGS. 3 and 4), such as formed in the two end portions of the protrusion 31 and intersected or communicating with the bore 32 of the protrusion 31 for receiving or engaging with two magnets or magnetic attractive elements 36, 37 respectively. The magnetic elements 36, 37 each include an aperture or orifice 38 formed therein and aligned with the bore 32 of the protrusion 31 for receiving or engaging with the pivot axle 33 and for allowing the magnetic elements 36, 37 to be solidly and stably anchored or retained or positioned to the casing 30 and for preventing the magnetic elements 36, 37 from being disengaged or separated from the casing 30 inadvertently.

Similarly, the magnetic members 20, 21 each also include an orifice or aperture 22 formed therein and aligned with the passage 17 of the seats 15, 16 of the housing 10 for receiving or engaging with the pivot axle 33 and for allowing the magnetic members 20, 21 to be solidly and stably anchored or retained or positioned to the housing 10 and for preventing the magnetic members 20, 21 from being disengaged or separated from the housing 10 inadvertently. The magnetic members 20, 21 are disposed close to or engaged or located beside the magnetic elements 36, 37 for acting with the magnetic elements 36, 37 respectively, best shown in FIG. 1.

In operation, as shown in FIGS. 1 and 2, the magnetic elements 36, 37 and the magnetic members 20, 21 may be acted or effected or attracted with each other for anchoring or retaining or positioning the casing 30 to the housing 10 at any selected or suitable angular position or location. One of the magnetic members 20, 21 may be good enough for acting with one of the magnetic elements 36, 37 for anchoring or retaining or positioning the casing 30 to the housing 10 at any selected or suitable angular position or location.

Accordingly, the container in accordance with the present invention includes an improved and simplified latching or positioning structure or configuration for latching or locating a cover to a housing or a container or reservoir body and for anchoring or retaining or positioning the cover to the housing at any selected or suitable angular position or location.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A container comprising:
a housing,
a casing pivotally connected to said housing with a pivot axle,
a magnetic member engaged in said housing, and
a magnetic element engaged in said casing and disposed close to said magnetic member for acting with said magnetic member and for anchoring and positioning said casing to said housing at a selected angular position.

2. The container as claimed in claim 1, wherein said housing includes a seat, and said magnetic member is engaged in said seat.

3. The container as claimed in claim 2, wherein said housing includes a slot formed in said seat, and said magnetic member is engaged in said slot of said seat.

4. The container as claimed in claim 2, wherein said housing includes a passage formed in said seat, and said pivot axle is engaged in said passage of said seat.

5. The container as claimed in claim 1, wherein said magnetic member includes an aperture formed in said magnetic member for receiving and engaging with said pivot axle.

6. The container as claimed in claim 1, wherein said casing includes a protrusion, and said magnetic element is engaged in said protrusion of said casing.

7. The container as claimed in claim 6, wherein said casing includes a bore formed in said protrusion, and said pivot axle is engaged in said bore of said protrusion.

8. The container as claimed in claim 6, wherein said casing includes a pathway formed in said protrusion, and said magnetic element is engaged in said pathway of said protrusion.

9. The container as claimed in claim 1, wherein said magnetic element includes an orifice formed in said magnetic element for receiving and engaging with said pivot axle.

10. The container as claimed in claim 1 further comprising a second magnetic member engaged in said housing, and a second magnetic element engaged in said casing and disposed close to said second magnetic member for acting with said second magnetic member and for anchoring and positioning said casing to said housing at the selected angular position.

11. The container as claimed in claim 10, wherein said housing includes a seat, and said second magnetic member is engaged in said seat.

12. The container as claimed in claim 11, wherein said housing includes a slot formed in said seat, and said second magnetic member is engaged in said slot of said seat.

13. The container as claimed in claim 10, wherein said second magnetic member includes an aperture formed in said second magnetic member for receiving and engaging with said pivot axle.

14. The container as claimed in claim 10, wherein said casing includes a protrusion, and said second magnetic element is engaged in said protrusion of said casing.

15. The container as claimed in claim 14, wherein said casing includes a pathway formed in said protrusion, and said second magnetic element is engaged in said pathway of said protrusion.

16. The container as claimed in claim 10, wherein said second magnetic element includes an orifice formed in said second magnetic element for receiving and engaging with said pivot axle.
